(19) United States
(12) Patent Application Publication
(10) Pub. No.: US 2010/0231434 A1
(43) Pub. Date: Sep. 16, 2010

(54) Structure

(76) Inventors: Jonathan Pinto, Northants (GB); James Christopher Gordon Matthews, Essex (GB)

Correspondence Address: KENYON & KENYON LLP, ONE BROADWAY, NEW YORK, NY, 10004, US

(21) Appl. No.: 11/921,353

(22) PCT Filed: Sep. 13, 2007
(86) PCT No.: PCT/GB2007/003448

§ 371 Date: May 27, 2010

(30) Foreign Application Priority Data
Sep. 22, 2006 (EP) 06270086.9
Sep. 22, 2006 (GB) 0618696.9

(51) Int. Cl. H01Q 17/00; E04H 12/00

(52) U.S. Cl. 342/4; 52/40

(57) ABSTRACT

A structure, and a method for modifying the design of a structure, are provided such that the structure includes features designed to reduce and preferably minimize the radar cross-section of the structure over one or more predetermined frequency ranges. A structure is provided having an inclined surface, wherein the angle of inclination is selected for which the level of radar cross section is below a local maximum in the sidelobes in each of the scattering patterns of incident electromagnetic radiation at frequencies within one or more predetermined frequency ranges. In the particular case of a tower, for example of a wind turbine, the radar cross-section of the tower may be minimized for two or more radar bands by appropriate selection of the angle of inclination of a frusto-conical portion of the tower. Ideally, the tower is constructed entirely in the form of a cone frustum.

### RELATED APPLICATION INFORMATION

This application is a United States National Phase Patent Application of, and claims the benefit of, International Patent Application No. PCT/GB2007/003448 which was filed on Sep. 13, 2007, and which claims priority to British Patent Application No. 0618696.9587.1, which was filed on Sep. 22, 2006, and which claims priority to European Patent Application No. 06279986.9, which was filed on Sep. 22, 2006, the disclosures of all of which are incorporated herein by reference.

### FIELD OF THE INVENTION

This invention relates to structures which conventionally have large radar signatures and in particular, but not exclusively, to improved structures having structural features that serve to reduce their radar cross-section (RCS).

### BACKGROUND INFORMATION

Currently, approximately 47% of planning applications for wind farms in the United Kingdom are objected to on the basis of their potential to cause interference to radar signals. Consequently, a number of government-sponsored projects have focussed either on mitigating these effects by improved radar signal processing or through the development of wind turbines with reduced radar signatures.

The extent to which a particular object scatters radar energy is characterised in terms of its radar cross section (RCS). The RCS of an object is dependent on the size and shape of the object and on the material from which it is made. In respect of a particular radar installation, the RCS of an object is also dependent on the relative positions of the transmitting and receiving antenna apertures of the installation, and on the angle of polarisation of the electromagnetic (EM) wave incident on the object.

### SUMMARY OF THE INVENTION

From a first aspect, the present invention resides in a structure, at least a portion of which comprises an inclined surface, wherein the angle of inclination of the inclined surface is selected to reduce the radar cross section of the structure at frequencies within one or more predetermined frequency ranges.

The inventors in the present case have realised that the RCS of a structure can be significantly reduced, in particular for a structure comprising a tower, by arranging for at least a portion of the outer surface of the tower to be inclined at a predetermined angle relative to the vertical. The angle of inclination is calculated to reduce the RCS of the tower over one or more selected frequency bands, providing a reduced RCS in each of the one or more frequency ranges whether or not the RCS is actually minimized in any one range.

Preferably, the angle of inclination is selected for which the level of radar cross section is below a local maximum in the sidelobes in each of the scattering patterns of incident electromagnetic radiation at frequencies within each of the one or more predetermined frequency ranges. If only one frequency range is being considered, then the angle of inclination may be chosen to correspond to approximately a minimum between sidelobes in the resultant scattering pattern. However, if considering two or more frequency ranges, then some compromise may be necessary such that at least one angle may be selected such that the values of RCS for each of the frequency ranges lies below a local maximum in the sidelobes of the respective scattering patterns. Preferably the values of RCS correspond to an overall minimum for the two or more frequency ranges.

Ideally, a tower in the shape of a cone frustum can be provided with an angle of slope for the sides of the cone frustum designed to minimize the RCS of the tower. However, a very tall frusto-conical structure may in practice require a very wide base. Preferably, in a compromise arrangement, the structure comprises a frusto-conical section supported on a cylindrical section.

Whereas it is known to provide structures in the form of towers made using at least one frusto-conical section, such structures are designed primarily for their aerodynamic and load-bearing properties, not in order to minimize their RCS. According to the present invention, with careful selection of the shape of a structure, in particular of the angle of inclination of the surface of the structure, the RCS of that structure may be reduced and preferably minimized.

A structure such as a tower comprising cylindrical and/or frusto-conical sections, and hence having a circular cross-section, is likely to have a substantially uniform RCS over a range of azimuthal angles, that is, the RCS will not have been minimized in respect of any one direction. However, if it is known that the RCS of the structure needs to be minimized in only one direction, for example because the structure is likely to be in the field of view of a single radar installation at a single known location, cross-sections other than circular may be used, subject to aerodynamic and other considerations, to further reduce the RCS of the structure in that one direction.

From a second aspect, the present invention resides in a tower that comprises a frustum section, wherein the angle of inclination of the surface of the frustum section is selected such that the level of radar cross section of the tower is below a local maximum in the sidelobes in each of the scattering patterns of incident electromagnetic radiation at frequencies within two or more predetermined frequency ranges.

Typical shaping angles vary according to the height of the tower and the relative geometries of the frustum and any other section, such as a cylindrical section (if required). Substantial reductions in monostatic RCS, preferably in the range of 10-20 dBsm, are achievable in a tower comprising a frusto-conical section, for example, using slope angles of less than 2° for most tower geometries at the frequencies of interest. Preferably, an angle is selected which gives good reductions in more than one frequency band in order to minimize the impact of the structure on the most widely deployed radar installations.

From a third aspect, the present invention resides in a wind turbine comprising a tower according to the second aspect of the present invention.

### BRIEF DESCRIPTION OF THE DRAWINGS

FIG. 1 is a representation of the structure of a known wind turbine tower;

FIG. 2 illustrates the principles of backscattering of incident radar radiation by a cylindrical structure;

FIG. 3 is a graph showing a typical sidelobe pattern in backscattered radiation by an electrically large cylinder at varying angles of inclination;

FIG. 4 shows how the RCS (at 3 GHz) of a conventional wind turbine tower may be varied through changes to the shape of a conical portion of the tower according to preferred embodiments of the present invention;

FIG. 5 shows how the RCS (at 10 GHz) of a conventional wind turbine tower may be varied through changes to the shape of a frusto-conical portion of the tower according to preferred embodiments of the present invention;

FIG. 6 is a 2D plot showing how the RCS of the frusto-conical portion of a tower varies with both angle of inclination and frequency;

FIG. 7 shows plots of the RCS of a frusto-conical portion of a tower at two different frequencies for the purpose of finding an optimum base diameter and hence slope angle according to preferred embodiments of the present invention; and

FIG. 8 shows a preferred structure for a tower, in particular a wind turbine tower, devised according to preferred embodiments of the present invention.

### DETAILED DESCRIPTION

Preferred embodiments of the present invention will now be described in more detail, by way of example only, with reference to the accompanying drawings.

A preferred embodiment of the present invention will now be described in the context of a wind turbine. Wind turbines are often deployed in open and exposed locations such as coastal or mountainous areas, and in large numbers forming so-called wind farms. Such locations are often likely to be within the field of coverage of coastal radar or air traffic control radar installations.

A wind turbine, for example one manufactured by Vestas Technology™, is a large structure comprising a tower, a nacelle to house a generator, and a two or three-blade rotor. The tower itself is approximately 80 metres tall. The inventors in the present case have modelled the electromagnetic properties of one of the wind turbines of Vestas Technology™, the V82 turbine, using a BAE SYSTEMS plc proprietary physical optics computer program called “MITRE”. The MITRE software was used to evaluate the monostatic (i.e. the transmit and receive antennas are collocated) radar cross-section (RCS) of the V82 turbine at 3 GHz in order to predict the magnitude of backscatter from the object. A commercially available hybrid computer program product called “FEKO” was used to perform the same evaluation of the V82 turbine at 10 GHz. These frequencies were selected to correspond to those of the radars of the major UK operators which may be broken down into two distinct bands: 2.7-3.1 GHz, covering air defence, civil and military air traffic control primary surveillance radars, and marine Vessel Traffic Services (VTS); and 9.1-9.41 GHz covering marine navigation radars, both shore-based and aboard civil/military small/large craft. In practice, a majority of the objections to proposed wind farm installations are raised by the operators of these radar types and it is highly probable that the same frequencies will be critical in other non-UK wind farm construction projects.

The results of the evaluations show that, from an RCS perspective, wind turbines can be considered to consist of four scattering component types: the blades (of which there are three on the V82 turbine); the nacelle, that houses the generator; the nosecone; and the tower. The predictions of backscatter generated by MITRE and FEKO for each of these component types were compared against those calculated using simple geometric optics-derived formulae for these components represented as simple shapes.

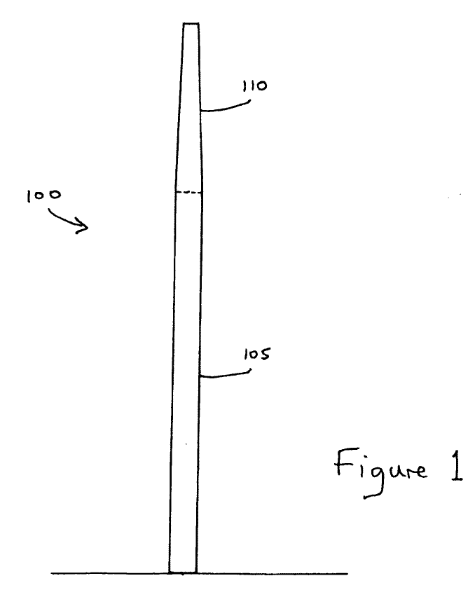

For the V82 turbine the RCS was found to be of the order of 57 dBsm at 3 GHz, increasing to 62 dBsm as the object ‘appears’ electrically larger at 10 GHz (approximating the 9.1-9.41 GHz band). This is an enormous radar signature; greater than, for example, typical RCS values for naval ships at most orientation angles. The greater proportion of the RCS, around 75% in the case of the V82, is a result of backscatter of radar energy from the tower. The structure of a V82, tower is represented in FIG. 1.

Referring to FIG. 1, the known tower structure 100 comprises a cylindrical portion 105, typically of rolled steel construction, 3.65 m in diameter and 54 m in length, supporting a truncated conical (frusto-conical) section 110, also of rolled steel construction, 24 m in length. The overall height of the tower is typically 78 m.

Since the greater part of the monostatic RCS of a wind turbine is derived from the tower, reduction in the RCS of the tower is considered critical to the development of a reduced radar signature wind turbine.

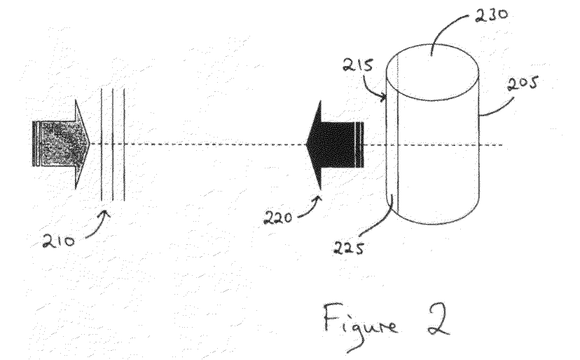

There are a number of known methods for evaluating RCS for simple structures such as that of a wind turbine tower. In particular, the text book “Radar Cross Section”, by E. F. Knott, J. F. Shaeffer, M. T. Tuley, Second Edition, Artech House, 1993, describes a general method for predicting RCS. Features of the “MITRE” software referred to above are described in a paper by A M Woods, C D Sillence and K D Carmody, entitled “Efficient Radar Cross Section Calculations on Airframe Geometries at High Frequencies”, Proc. Second Test and Evaluation International Aerospace Forum, AIAA, London, 1996. However, irrespective of the technique used for evaluating RCS of a structure, the inventors in the present case have found that by adjusting the angle of inclination of a surface of a structure, for example a wind turbine tower that comprises a section that is conical in shape, the RCS of the structure may be minimized. The principles of RCS evaluation that demonstrate the beneficial effects of the present invention will now be described in outline with reference to FIG. 2.

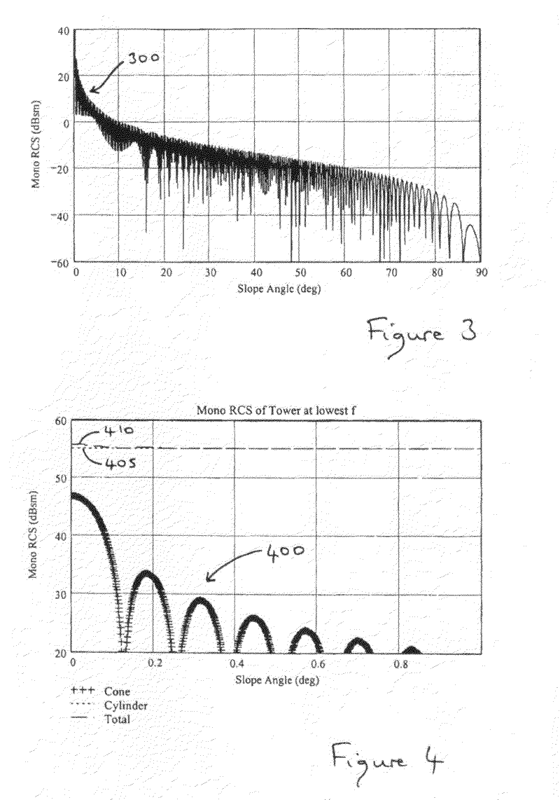

Referring to FIG. 2, if the structure is assumed to be a simple upright cylinder 205, and an illuminating radar signal 210 is incident on the cylinder 205 from a horizontal direction, the microwave energy of the radar signal 210 will arrive and be scattered in phase along an infinitely thin “line” 215 running all the way along the length of the cylinder. In practice, coherent scattering, as modelled using evaluation techniques based upon physical optics, is assumed to result from plane wave illumination of a surface where the curvature of the surface is such that the total phase variation (over that surface) in a reflected wave 220 is less than one eighth of a wavelength—the so termed “Stationary Phase Zone”. This zone forms a band 225 whose extent around the cylinder 205 either side of the “line” 215 varies as a function of frequency, being wider at low frequencies. The width of this band may be determined by conventional techniques, such as those referenced above, at each of the frequency bands of interest. However, the inventors in the present case have found that if the angle of the incident radar wave is changed slightly so that the incident radiation is no longer normally incident but is elevated or depressed, then specular scattering from the cylinder 205 no longer reaches the receiving aperture of the radar. The scattering is then governed by returns from the sidelobes in the scattered radiation. Within an overall sidelobe envelope, the sidelobes are periodic with increasing angle from normal incidence and hence at some angles the RCS may be significantly lower than at other angles that differ by only a fraction of a degree. The periodicity of the sidelobes is governed by discontinuities in the currents induced on the surface of the cylinder 205, in this example caused by the ends 230 of the cylinder. Hence, long cylinders yield very narrow sidelobes with high periodicity with increasing angle, while short cylinders yield wide sidelobes with low periodicity. A typical sidelobe envelope and periodic sidelobe pattern for a cylinder is shown in FIG. 3.

Referring to FIG. 3, it can be seen from the steeply sloping section 300 of the sidelobe envelope that even a small angle of inclination from normal incidence, of only one or two degrees, results in a significant reduction in RCS. However, as will be emphasised below and as can be seen from FIG. 3, within the overall sidelobe envelope the periodic sidelobe pattern varies significantly with very small variations in angle of inclination, providing an opportunity, in a preferred embodiment of the present invention, for fine tuning of RCS through careful choice of angle. These effects occur similarly if, instead of tilting the angle of illuminating radiation of a cylinder 205 by a small angle away from normal incidence, the illumination remains horizontal but the sides of the cylinder are sloped to form a cone. In this case the RCS differs somewhat as the radius varies linearly along the length of the cone in addition to the effect on the RCS of a transverse electromagnetic wave being off-normal.

The inventors in the present case have developed a simple mathematical routine, based to some extent on principles described in the published references cited above, to predict the RCS of a wind turbine tower as a function of frequency and angle, i.e. for a tower comprising a truncated cone portion supported on top of a cylindrical portion. By careful selection of the cone and cylinder heights and the cone angle, the present inventors have demonstrated that it is possible to ensure that the radar cross section of the tower, from the perspective of a particular radar receiving aperture, is minimized for the two preferred frequency bands mentioned above. This is achieved by ensuring that illumination of the cone portion from the horizontal direction at both those frequency bands results in scattered radiation at or near respective minima in the sidelobe pattern within the sidelobe envelope. This gives rise to a greater reduction in RCS than would be achieved by simply altering the geometry of a tower from a simple cylinder to a cone of arbitrary slope angle. In that instance, the arbitrarily chosen slope angle may correspond to a sidelobe maximum being detected at the radar receiving aperture rather than a minimum in the sidelobe pattern.

In summary, the reductions in radar cross section achievable according to preferred embodiments of the present invention, relative to the RCS of a simple cylinder, are of two types. Firstly, conversion of the simple cylinder into a frusto-cone of an arbitrary cone angle, typically of 1 or 2 degrees, results in a significant reduction in the radar cross section consistent with the overall sidelobe envelope. Secondly, the sidelobe radiation pattern within that sidelobe envelope consists of a series of maxima and minima as described previously and hence the RCS can be further reduced, from the perspective of a particular radar receiving aperture, if a cone angle is chosen so that radiation scattered from the cone and detected by the radar is at or near a minimum in the sidelobe pattern at the frequency bands of interest. This is possible because the variation in periodicity of the sidelobes with cone angle is frequency dependent. This variation in periodicity and other aspects will now be demonstrated and described with reference to FIGS. 4, 5 and 6. These figures are provided in the context of an existing design of wind turbine tower having a cylindrical portion and a frusto-conical portion in the proportion (54 m to 24 m respectively) as described above with reference to FIG. 1.

Referring firstly to FIG. 4, assuming illumination by radiation of a frequency of 3 GHz—the lower of the two radar bands of interest—three graphs 400, 405 and 410 of RCS are provided. The graph 400 shows how the RCS (sidelobe pattern) of the smaller frusto-conical portion of the tower would vary if its slope angle were to be varied between 0° and 1°. The graph 405 shows the RCS of the cylindrical portion as being fixed at approximately 56 dBsm; the cylinder surface being of fixed slope. The graph 410 shows how the total RCS for the tower would vary if the slope angle of the frusto-conical portion were varied between 0° and 1°, taking account of the contributions from the cylindrical portion and the frusto-conical portion. It can be seen that for a wind turbine tower according to an existing design, where the cylindrical portion is significantly longer than the frusto-conical portion, the total RCS of the tower reduces only slightly as the slope of the frusto-conical portion is increased from 0° to 0.2° but negligibly thereafter. However, FIG. 4 does emphasise that if the tower can be designed so as to comprise as great a proportion as possible in the form of a cone frustum, the RCS of the tower would reduce much more considerably with increasing slope angle of the cone frustum, in the limit corresponding to a plot similar to that shown in the graph 400 if the tower were to comprise only a frusto-conical portion.

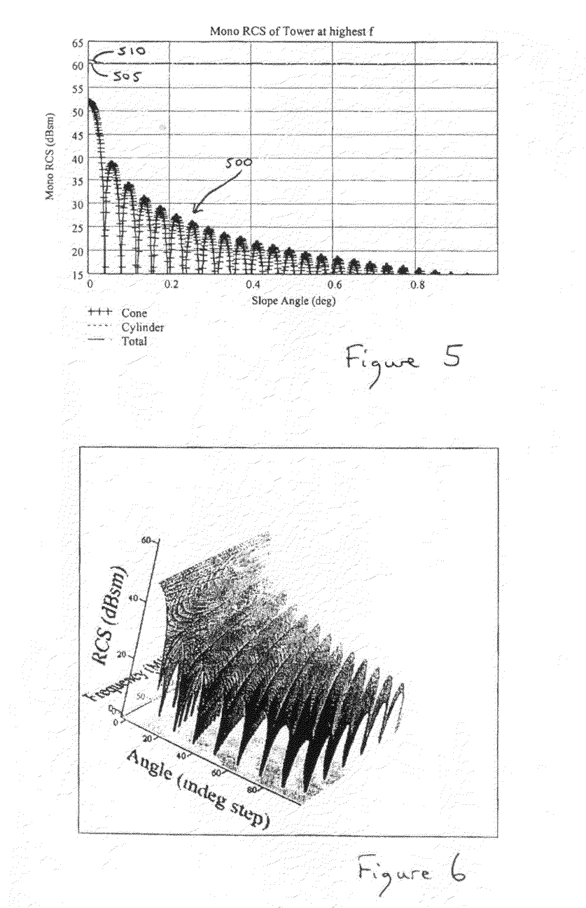

Referring to FIG. 5, a similar set of graphs 500, 505 and 510 are provided to those of FIG. 4 in respect of the same tower design, on the basis of illumination by radiation of frequency 10 GHz—approximating the higher of the two radar bands of interest. It can be seen, in particular, by comparing the periodicity in the sidelobe pattern 400 of FIG. 4 with the pattern 500 of FIG. 5, that the periodicity in the sidelobe pattern relating to the frusto-conical portion increases with increasing frequency of illuminating radiation. This provides an opportunity for finding an optimal slope angle corresponding to sidelobe minimum at two different frequencies.

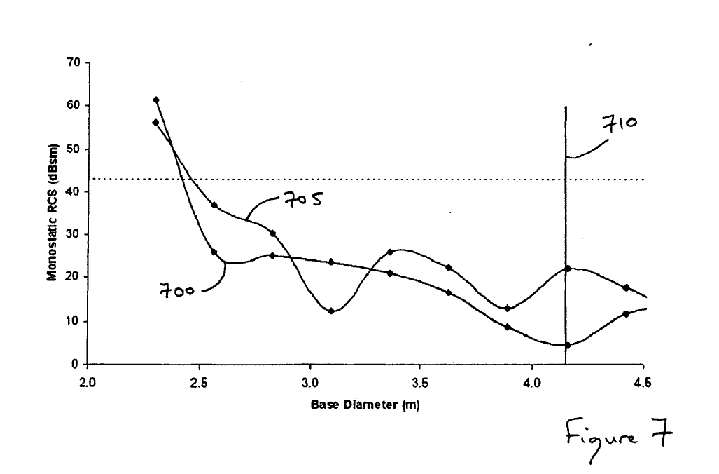

Referring to FIG. 6, a 2D plot is provided showing how RCS varies with slope angle of the frusto-conical portion of a tower and with frequency, showing in particular the increase in periodicity of the sidelobe pattern of scattered radiation with increasing illumination frequency.

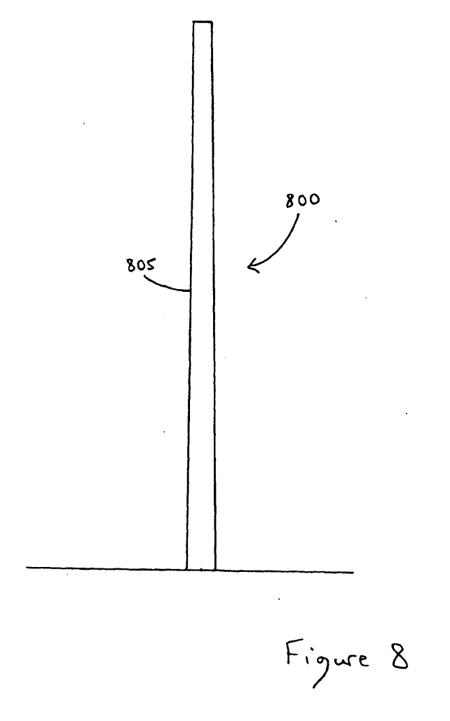

In practice, a preferred process for designing a tower or other similar structure having minimal overall RCS at one or more frequencies, according to preferred embodiments of the present invention, would use RCS graphs similar to those generated in FIG. 4, 5 or 6 through modelling of the structure with known RCS evaluation techniques as described and referenced above. However, taking account of practical constraints in the configuration of a tower, in particular, the graphs 400 and 500 in FIGS. 4 and 5 respectively may be converted to show the variation of RCS for a frusto-conical portion in terms of the base diameter of the cone frustum, rather than in terms of the angle of slope, for each frequency of interest. The converted graphs may then be shown on the same plot in order to identify an optimal base diameter (slope angle) for the cone frustum, as shown for example in FIG. 7.

Referring to FIG. 7, a graph 700 of RCS for a cone frustum for 3 GHz radar and a graph 705 of RCS for a cone frustum for 10 GHz radar are shown. It is a relatively simple exercise to identify an optimal base diameter 710 for the cone frustum, in this example at approximately 4.15 m, corresponding to a slope angle of approximately 0.6°, if necessary within a practically convenient range of diameters, that results in a minimal overall RCS. FIG. 7 demonstrates that it is possible to construct a tower, in particular a wind turbine tower, comprised only of a cone frustum that with slope angle chosen according the method described above minimizes radar cross-section at both the main radar frequency bands in the UK. A preferred tower structure resulting from this method is shown in FIG. 8.

Referring to FIG. 8, a tower 800 is shown to comprise a cone frustum having a surface 805 whose angle of inclination is selected according to preferred embodiments of the present invention to minimize the radar cross-section of the tower at two radar frequency bands.

Preferably, an automated process may be implemented to identify the optimal base diameter/slope angle by the solution of simultaneous equations, one for each frequency, or by means of an iterative technique.

It can be seen from the above that, in the ideal case, a tower is comprised solely of a simple cone frustum, but in practice some cylindrical part may be required to ensure that the diameter of the tower base does not exceed the maximum permitted diameter for transport by road, for example. As a further practical constraint, the upper diameter of the cone frustum for use in a wind turbine tower is typically set at around 2.4 m for the purposes of interfacing with the nacelle. However, according to the present invention, such constraints may be taken into account in providing effective means of RCS reduction for a wind turbine tower, and for similar structures, by shaping. Conveniently, parameters defining the design of a minimal-RCS structure, a tower for example, may be calculated and listed in tables so that the process of tower design may be reduced to one of looking up slope angles or other parameters defining the structure according to the frequency or combination of frequencies for which RCS is to be minimized.

Whereas there may be scope for reducing the RCS of an existing structure by making a slight modification to a part of the structure, for example by altering the angle of slope of a frusto-conical section of the structure, or replacing that section, it may be that the dominant contribution to RCS arises from a part of the structure that cannot be economically changed. For example, if the cylindrical portion of an existing wind turbine tower is the dominant contributor to overall RCS, then subtle changes in the slope of a frusto-conical section supported by the cylinder may make little difference to the overall RCS of the tower. This was demonstrated above with reference to FIG. 4 and FIG. 5. However, although an expensive solution in practice, cladding of the cylindrical portion to create a more conical overall shape, at an angle of slope selected according to the present invention, may have a beneficial effect in reducing the overall RCS of the structure. Preferably the shaping of a structure according to the present invention may be combined with the use of radar absorbent materials, in particular when applied at least to that part of the structure making the largest contribution to the overall RCS of the structure, for example to the cylindrical portion of a wind turbine tower, to further reduce the radar signature of the structure beyond that achievable through shaping alone.

The present invention may be applied, potentially, to any structure in which shaping has the potential to yield RCS reduction. In general, shaping will provide the most significant reductions in RCS for structures which are highly reflective of radar signals, particularly metallic structures. However, shaping may be applied to structures which are not metallic, or which comprise a combination of metallic and non-metallic parts such that when shaped according to the present invention there is a reduction in the overall RCS of the structure.

1-9. (canceled)

10. A structure comprising an inclined surface, wherein the angle of inclination of the inclined surface is selected to reduce the radar cross section of the structure at frequencies within one or more predetermined frequency ranges.

11. The structure according to claim 10, wherein the angle of inclination is selected for which the level of radar cross section is below a local maximum in the sidelobes in each of the scattering patterns of incident electromagnetic radiation at frequencies within said one or more predetermined frequency ranges.

12. The structure according to claim 11, wherein the angle of inclination is selected for which the radar cross-section of the structure is reduced within each of two or more different radar frequency ranges.

13. The structure according to claim 12, wherein the radar cross-section of the structure is reduced to a combined substantially minimum level over a frequency range of 2.7 to 3.1 GHz and a frequency range of 9.1 to 9.41 GHz.

14. The structure according to claim 11, comprising a frusto-conical section.

15. The structure according to claim 14, in the form of a tower comprising a substantially cylindrical section supporting said frusto-conical section.

16. A tower comprising a frustum section, wherein the angle of inclination of the surface of the frustum section is selected such that the level of radar cross section of the tower is below a local maximum in the sidelobes in each of the scattering patterns of incident electromagnetic radiation at frequencies within two or more predetermined frequency ranges.

17. The tower according to claim 16, wherein the angle of inclination is selected such that the overall radar cross section of the tower over said two or more frequency ranges is substantially minimized.

18. A wind turbine comprising:
a tower, the tower including:
a frustum section, wherein the angle of inclination of the surface of the frustum section is selected such that the level of radar cross section of the tower is below a local maximum in the sidelobes in each of the scattering patterns of incident electromagnetic radiation at frequencies within two or more predetermined frequency ranges.
